(19) United States
(12) Patent Application Publication
(10) Pub. No.: US 2008/0270019 A1
(43) Pub. Date: Oct. 30, 2008

(54) Systems and methods for enhancing private transportation

(75) Inventors: Jeffrey Paul Anderson, Encinitas, CA (US); Vivek Prabhakar Kamath, San Diego, CA (US)

Correspondence Address: High Regard Software, Inc., 1452 Ranch Road, Encinitas, CA, 92024, US

(73) Assignee: High Regard Software, Inc., Encinitas, CA (US)

(21) Appl. No.: 12/005,845

(22) Filed: Dec. 28, 2007

Related U.S. Application Data
(60) Provisional application No. 60/882,806, filed on Dec. 29, 2006.

(51) Int. Cl. G01C 21/34; G06Q 99/00

(52) U.S. Cl. 701/201; 705/1; 701/206

(57) ABSTRACT

Systems and methods are disclosed for enhancing the convenience, security, and efficiency of ridesharing through the incorporation of trusted communities, geotemporal routing algorithms, and by providing monetary incentives and privacy safeguards to encourage system growth.

### BACKGROUND

1. Field of the Inventions

The field of the invention relates generally to enhanced private transportation systems and methods that integrate personal communications, networking, and navigation technologies to enable travelers to better utilize current transportation systems by more efficiently and safely sharing rides, and more particularly to a centrally controlled system and method for achieving these objectives.

2. Background Information

The sharing of rides in private automobiles represents a largely underdeveloped resource for relieving traffic congestion and reducing transportation costs for both rider and driver. As such, it holds the potential for significant social and economic benefit. Government and private efforts to encourage ride sharing or “car pooling” have so far met with limited success as the percentage of single occupancy vehicles on the highways amply demonstrates. Reasons for not car pooling abound, including: incompatible working hours and/or route locations, safety, and personal issues such as smoking, eating, talking, hygiene, tardiness, etc. Perhaps the foremost reason is simply that travelers enjoy the spontaneity and freedom that comes with being behind the wheel. However, a number of emerging factors are converging, such as rising gas prices and increased highway traffic, that increasingly militate against single occupancy vehicle traffic. For these and other reasons, there remains a need for an improved system that would enable willing drivers and passengers to ride share in a cooperative and efficient manner.

### SUMMARY OF THE INVENTION

The private transportation system of the present invention, generally referred to hereinafter as “RideGrid” or “the RideGrid system”, overcomes many of the limitations of the prior art including providing independent verification of parties' identity and attributes, and efficient geographic and temporal (“geotemporal”) routing and matching of compatible shared rides between Driver and Rider. The RideGrid system may include specific functional elements to help accomplish its objectives such as a registration function, a routing function, and an affiliation or subscribe to community function.

Operations carried out under the RideGrid registration function may include collecting relevant personal information such as name, address, driver's license or other government ID, employer name, insurance provider, and so forth. For those persons intending to provide rides, the RideGrid registration function may further include vehicle related information such as the make, model, color, year, license plate, registration information, insurance coverage and company, and driver related information such as Driver's license and driving record. Drivers may be asked to sign an agreement indicating that these data will be kept up to date and may be prompted periodically to verify their personal data when they log into their RideGrid account. The registration function for Driver or Rider may also include some form of registrant authentication such as self verification of applicant's Email address, or other forms of trusted third party verification. The registration function results in unique RideGrid user and account ID registrations that provide means for uniquely identifying the registrant and their account.

The RideGrid system may also include a routing function that utilizes participants' geotemporal occupancy information from which routing and ride matching functions can be accomplished. This occupancy information may include locations where a member is frequently located such as home, work, school, and similar regularly occupied locations along with time schedules according to which the member regularly travels between these locations. The RideGrid system can accommodate both scheduled and unscheduled matches. For unscheduled matches, e.g., those sought with less than four hours notice, a database associated with the RideGrid routing function may be frequently updated to include ad hoc or transient data to accommodate unscheduled Driver availability and Rider requests. The RideGrid routing function utilizes these scheduled or unscheduled geotemporal occupancy data, along with member preferences and other related information, to provide optimal choices for ridesharing between Drivers and Riders.

The RideGrid system may further include an affiliation function whereby registrants can become affiliated with existing communities, e.g., work place or school affiliations, online social networking affiliations, or by creating new ones or “buddy lists” from family, friends, colleagues, and/or acquaintances. These community affiliations, chosen by the registrant, provide a pool from which potential ride sharing matches between Riders and Drivers can be drawn.

The RideGrid system may further include a participation incentive function whereby Riders buy credits and Drivers earn credits based on passenger occupancy and miles driven. For example, Riders may purchase credits in incremental amounts to be used for future miles traveled and Drivers may earn credits on a similar basis. RideGrid may be structured such that a central entity overseeing RideGrid can deduct fees for system operation and maintenance from purchases or sales of these credits. RideGrid may be the only entity that is able to buy and sell such credits. RideGrid incentives may additionally include credits for creating and administering participating communities, and referring people who utilize the service and/or purchase credits.

The RideGrid system may additionally utilize cell phones, personal digital assistants (PDA's), portable global positioning systems (GPS) and navigation systems, and other such communications, networking, and position locating and navigating systems to enhance, streamline, or improve the flexibility, efficiency, and functionality of the system.

These and other features, aspects, and embodiments of the invention are described below in the section entitled “Detailed Description of the Preferred Embodiments.”

### BRIEF DESCRIPTION OF THE DRAWINGS

Features, aspects, and embodiments of the inventions are described in conjunction with the attached drawings, in which:

FIG. 1 depicts an exemplary overall RideGrid system architecture of a proposed embodiment of the RideGrid system.

FIG. 2 depicts an exemplary architecture of the server component of a proposed embodiment of the RideGrid system.

FIG. 3 depicts an exemplary logical flow chart for the RideGrid Registration function.

FIG. 4a depicts an exemplary logical flow chart for the RideGrid Routing function.

FIG. 4b depicts an exemplary driver route determined through the routing function and showing start, end, and waypoints.

### DETAILED DESCRIPTION OF THE PREFERRED EMBODIMENTS

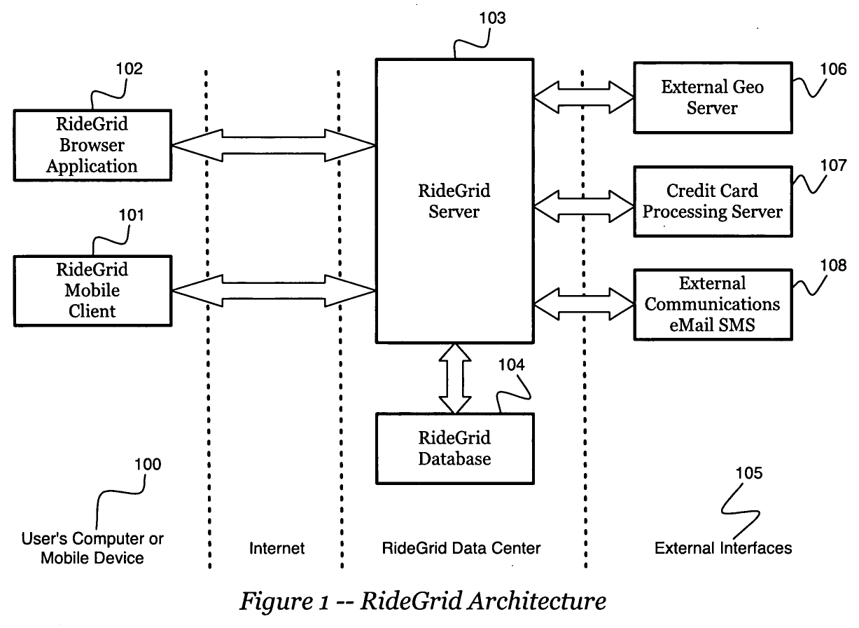

FIG. 1 illustrates one exemplary embodiment of a RideGrid system depicting a 3-tier architecture comprising a user interface device or “Client” such as a mobile device (101) or computer (102) with network connectivity to a network “Server” (e.g., a JavaServer Pages object model for creating dynamic Web content), a “Database” tier (104), and various external interfaces (105) that may include an external geospatial server (106), a credit card processing server (107), and links to external communications services such as Email and Short Message Service (108).

The RideGrid Client forms the user facing component of the system. There are two types of clients that can be used to interact with RideGrid. The RideGrid Browser Application (102) is a browser-based client application; i.e., one that runs within a standard browser environment such as those typically found on a user's desktop computer. This application allows the user to utilize the complete set of RideGrid functionality, which includes creating an account and initial sign-up, account maintenance, community creation and maintenance, credit management, and requesting and offering rides. The second type of client is the RideGrid Mobile Client (101), which is typically a “thin” application intended to run on a user's mobile device. The RideGrid Mobile Client (101), because its possibly limited capability, may provide a subset of RideGrid functionality. Primary functions implemented on the Mobile Client are ride requesting and ride offering functions. As mobile devices become more capable, more functions can be added.

The RideGrid Server (103) provides a scalable server platform for all RideGrid clients. It implements the object model necessary to provide all functionality for RideGrid. This involves several sub-systems like registration, credit management, ride management, community management, and other functions as described below.

The RideGrid Database (104) provides a scalable relational database for storing all information related to the RideGrid system. Implementation of this module, as described in further detail below, may comprise a single database, or may comprise several databases that provide RideGrid system all the scalable storage needs required.

RideGrid may also include a number of External Interfaces (105) that may rely on third party providers for functions such as geographic routing capability (106), or credit card processing (107). Email interactions (108) are also classified as third party even though they may be hosted by the RideGrid datacenter. As is known in the art, a third party product may be used to satisfy this functionality.

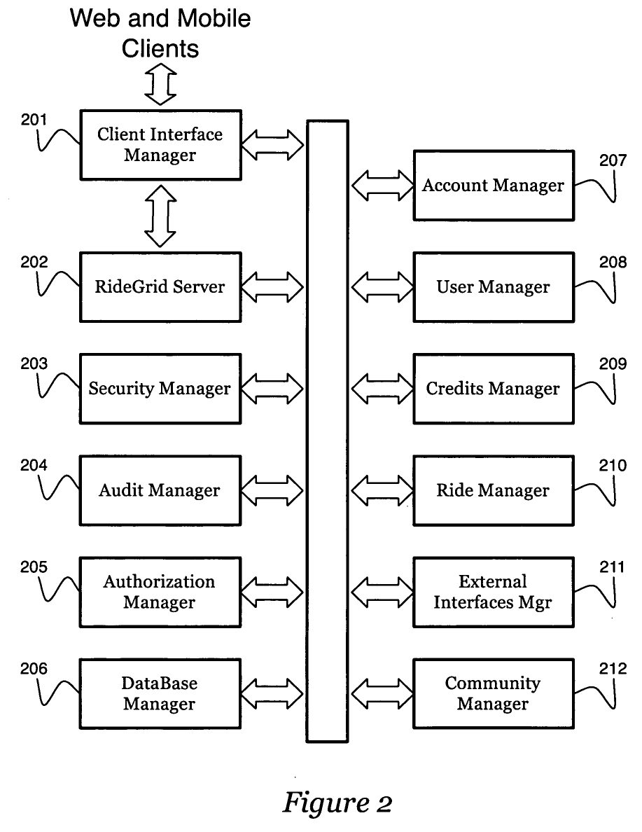

The RideGrid Server (103) comprises several sub-systems as depicted in FIG. 2. The Client Interface Manager (201) provides an entry point for RideGrid clients (101, 102). The Client Interface Manager is responsible for accepting requests from clients in different data formats and translating them to a native format for local processing. On the response side, the Client Interface Manager is responsible for translating data into the format required by client. In the case of desktop based clients, complete Web pages may be sent from server to client and in the case of hand-held clients, the server may send data either in XML or some predefined format designed for local processing. As functionality and memory capacity on mobile devices increases, the data form is expected to evolve and is thus, flexible, depending on mobile device capabilities. This component can also be expanded into a Web service so that remote clients can call Web service remote procedure calls (RPC's) and vice versa. This functionality can be implemented in many different forms, including but not limited to Web Services, Java ServerPages, IIS/ASP, .NET, etc.

RideGrid Server (103), through its Client Interface Manager (201), forms the internal entry point into the server. This component supports all the external client needs and provides a single point of entry and exit from the RideGrid system. This architecture greatly reduces the surface area of the application to external world thereby enhancing application security. All data passed to and from RideGrid Server (103) is in the form of “RideGrid Control Block”. RideGrid Control Block indicates the function that server needs to perform and packages associated data required for processing. Internally, RideGrid Server (103) can call into several other Managers (e.g., 207-212) to satisfy a request. All Managers are aware of RideGrid Server and it forms a container for common functions like security (203), auditing (204), authorization (205), and database management (206). RideGrid Server (103) will orchestrate all required components to fulfill a function required by the Client Interface Manager (201).

The RideGrid Server Architecture includes various Manager components as depicted in FIG. 2. The Account Manager (207) provides all account management functions. Based on the function selected by the client, Account Manager (207) will handle creation, maintenance and deletion of accounts. Account Manager (207) will request RideGrid Server for other Managers to satisfy account request. An example could be getting a new User and associating them with a current account. That function would be performed by RideGridServer as a part of processing the AccountCreation request. User Manager (208) provides all user management functions. Based on the particular function selected by the client, User Manger (208) will handle creation, maintenance, deletion and fetching of a RideGrid user and related data. This component can also handle all user-related information like vehicles, phones, community memberships etc.

A Credits Manager (209) handles all credit-related functions, including buying and selling credits, and transferring credits between users in a secure way. This function also handles any changes to the monetary rate at which credits are valued. Ride Manager (210) carries out several ride matching related functions such as interfacing with external systems for route processing, and geo-processing, geo-coding and reverse coding information, and preference matching for users. An External Interfaces Manager (211) provides overall support functionality for other RideGrid components such as abstracts to a variety of external interfaces like Email, credit card system, geo system, and allowing RideGrid to remove one external service provider and substitute another provider. The Community Manager (212) provides management of communities, which use authentication credentials established by the community creator. It provides capability to add, remove, and update communities, allow membership administration, and other community related functions. The Community Manager (212) can also provide a standardized naming convention and search functions.

The Security Manager (203) provides authentication of the RideGrid user. Email ID and a PIN (Personal Identification Number) are used for authentication. This component may use a simple authentication database lookup to make sure that user ID and PIN are valid, although the authentication protocol can be extended to incorporate any type of authentication schemes as deemed necessary; e.g., Directory based, Domain Controller based, Kerberos based, certificate based, etc. This component uses a simple authentication database lookup to make sure that user ID and PIN are valid. As in any authentication procedure, authorization information is retrieved from the Database (104). The Security Manager (203) can administer different functionalities, depending upon the role of the User. For example, if the User role is not Community Administrator, User should not be presented “Community Management” functions but rather “Join Communities” functions. Functions required to support authentication include authorization and audit control. Once a User is authenticated and authorization information gathered from the Security Manager (203), RideGrid Server calls into Authorization Manager (205) with the authorization mask and operation type to make sure that a given operation is valid for a particular security credential.

The Audit Manager (204) functions to prevent repudiation. If a component requires audit, after and before an operation, an audit log will be written by Audit Manager (204). Participating components will indicate if, as in most cases, auditing is required. Audit Manager (204) will have a concept of transaction ID, for each audit log, transaction ID, date time and component specific details will be logged. Authorization Manager (205) provides authorization capability for all components of the system. RideGrid Server will make sure by querying Authorization Manager (205) if given user account is allowed to perform a certain operation in RideGrid system. Database Manager (206) may be a separate component, depending on the size of the RideGrid database. As database size increases, partitioning may become necessary. This component keeps a list of partitioning information and, based on the key provided by a given component, returns the appropriate database connection for a component to consume. It is possible that connections need to be pooled and this function is left to the underlying Connection Manager.

RideGrid Database (104) provides a persistent and continuously available store for all RideGrid data providing the following properties: Relational Database capability; replication capability; clustering support for redundancy; and ACID (Atomicity, Consistency, Isolation, and Durability) support. These properties are satisfied by a standard Structured Query Language (SQL) compliant database such as MySQL and schemas for implementing such SQL compliant databases are familiar to those skilled in computer database systems. It is expected that RideGrid Database (104) is used primarily as a data store and will have very simple access methods like add, modify, delete and fetch methods on any entity. All of the logic of managing the data will be in each of the Server Managers. This arrangement allows the flexibility of changing database stores in response to the evolving requirements of the system.

The RideGrid Architecture, as depicted in FIG. 1, may advantageously provide the following functions: Registration, routing, affiliation, credit purchase, incentive, and request or offer a ride. Users can enter the RideGrid system by various means including logging in through a Web portal, by virtue of a preselected routing schedule, or spontaneously through use of a mobile communications device. Access to the system may be accomplished by means of an Internet connected computer or mobile device, or by any channel that is conveniently accessible using a stationary or mobile communications device such as SMS (Short Message Service) text messaging.

RideGrid attempts to match complementary users (Drivers or Riders) based on the overall compatibility of various criteria associated with each user. These criteria data may include, for example, user preferences, buddy or block lists, community affiliations, etc. Scores indicative of the compatibility between individual users may be derived based on these criteria data. Users who are Drivers provide additional information as to their geotemporal routing schedules and the maximum deviations of time and distance from their normal routes they are willing to accommodate. Based on this information, boundaries around their normal routes are instantiated that define the areas within which they are willing to accept Riders. Temporal boundaries associated with each Driver route are also set, depending on the time frame during which the Driver is able to accommodate Riders. The temporal boundary may be derived based on inputs such as a Driver's expected range of departure times, the distance to be traveled, and the existing or expected traffic conditions. Users requesting rides that meet other compatibility criteria are matched with Drivers for which the Rider's departure, destination, and time criteria are within the boundaries calculated for that Driver's expected route.

As an example of how Driver and Rider matching might be accomplished using RideGrid, assume a Driver normally leaves home at location “A” between 7:00 and 7:15 AM, travels a route passing close to location “B” between 7:45 and 8:05 AM, and arrives at work at location “C” between 8:30 and 9:00 AM. Also assume a Rider requests a ride through RideGrid asking to be picked up at location B sometime between 7:30 and 8:00 AM and taken to location “D” near location C. In this example, there is a high degree of geotemporal compatibility between Driver and Rider. Assuming that locations B and D lie within the acceptable geographic boundaries of Driver's normal driving route, only a small temporal incompatibility exists between Driver and Rider. Specifically, Driver is normally near B between 7:45-8:05 AM, whereas Rider wishes to leave no later than 8:00 AM. Assuming a normal probability distribution, Driver's most likely arrival time at location C would be 7:55 AM, and the probability that Driver would arrive after 8:00 AM can be reasonably estimated and entered into an overall compatibility rating for this ride match. RideGrid can also calculate the expected arrival time at Rider's desired destination D, for which the Rider may also specify an acceptable range of arrival times, which may be entered in lieu of departure times. Travel times can be estimated based on route metadata such as quasi real time traffic updates, or historical data for a particular route and time period. The preceding scenario could also apply where a Rider requests a ride on short notice and RideGrid attempts to find a match with a compatible Driver route in essential real time.

In practice, perfect Rider and Driver matches will seldom be achieved, but RideGrid can provide close matches from among which both Rider and Driver are free to select the one they deem most acceptable. Drivers and Riders are always free to decline or ignore rideshare offers. However, when a rideshare agreement is reached between the parties, RideGrid removes the Rider's request from the system. Drivers on the other hand remain active in the RideGrid system during any time periods within which their occupancy limit has not been reached.

The RideGrid system can periodically add potential Drivers for a Rider to the Rider's client list. For each potential Driver, RideGrid calculates a composite route so that the cost in RideGrid credits and estimated arrival time can be presented to the Rider. Information presented to the Rider may also include their member evaluation rating. No personal information regarding their identity or information irrelevant for the transaction, such as address, phone number, or other such confidential information between parties is ever disclosed by RideGrid. If a Rider selects a Driver from the list of potential clients, the Driver is sent a message offering the proposal. If the Driver accepts, both parties are notified and the Driver is sent ride related information which can include detailed routing directions. The routing directions function can be carried out by integrating RideGrid's ride related data with third party mapping providers such as MapQuest, Yahoo! Maps!, Expedia, or similar Web-based routing services.

RideGrid can send a photo ID of the Rider to the Driver for verification purposes. Similarly, the Rider may be given Driver attributes such as a photo ID, and the make, model, and color of their car. The exchange of photo ID's between Rider and Driver constitutes a form of biometric verification proving that each user is who they say they are. Some or all of this identification information may be withheld until after a ride agreement has been reached in order that such information will not be used prejudiciously in the ride decision. As can be readily appreciated, the exchange of photographs is predicated on one or both parties having photo-capable mobile devices, which includes many cell phones and PDA's. In the absence of such capability, a simple token can be exchanged, which is a shared secret proving that they are the member who initiated the transaction. Both parties may also be mutually informed by RideGrid as to whether they each possess Internet enabled mobile devices and/or Global Positioning System (GPS) devices. The possession of these devices will enable RideGrid to alert the parties regarding their proximity, at which point the Rider can hold up their hand or a sign and the Driver can look for someone matching the photo ID or other identifiable characteristic. Upon meeting, the Driver may initiate a confirmation procedure by which RideGrid rings the Rider's cell phone or queries their mobile device requesting confirmation. If confirmation is returned by the Rider, it is forwarded to the Driver thus assuring both parties of a correct ride match.

Once the verification process is complete, the Rider may join the Driver who then proceeds to the agreed destination following the routing instructions provided. Upon arrival at the destination, the Driver initiates the Ride Completed sequence, whereby the RideGrid Server (103) sends a message to the Rider's mobile device asking for confirmation that the ride has been completed. Opportunities may be provided at a later time by RideGrid to both Driver and Rider to evaluate each other's performance. This information can then be entered into each party's profile and made available to inform future transactions. In the event a Rider fails to respond to the confirmation request within a reasonable time period of expected arrival, RideGrid may then assume the ride was completed and transfer ride credits from the Rider to the Driver. On the other hand, if the Driver says the ride was completed, but the Rider responds that it was not completed, then the RideGrid system may incorporate features that provide the functionality to query parties regarding the discrepancy and determine the proper response. This may include various options such as crediting the Driver from a credit reserve instead of from the Rider's account, downrating the Driver and/or Rider, or completely disabling one or both parties in the RideGrid system.

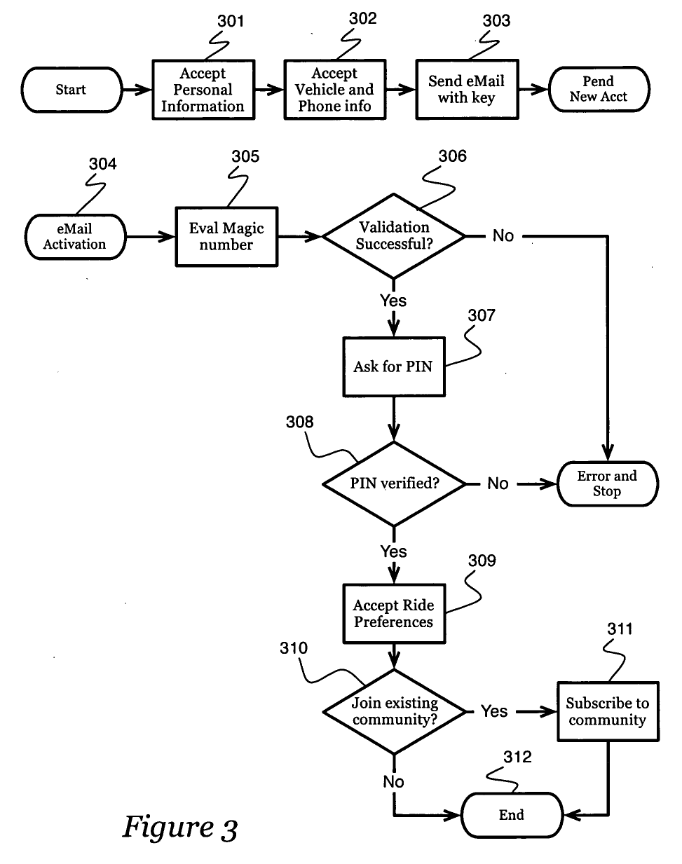

The Registration Function, as depicted in the exemplary logic flow diagram of FIG. 3, is the process of entering basic information about individuals and accounts. To start the registration process, at step (301) the user enters basic personal identify information such as name, address, driver's license or other verifiable ID, employer name, insurance provider, and so forth. This data is never divulged to any individual, it is used solely by RideGrid for identity and insurance purposes only. At step (302), users also enter the identities of their mobile phones they intend to use with RideGrid. For other mobile devices, the identity is dynamic and does not require pre-registration. If a user intends to provide rides, they must also provide RideGrid with registration data pertaining to their vehicle(s). This includes any or all of the following vehicle related information: make, model, color, year, license plate number, registration information, and insurance coverage and company. A user may be required to sign an agreement requiring this data to be kept up-to-date, and that intentional falsification of information is fraud for which they could be prosecuted. A Driver may also be required to prove to RideGrid that such insurance is valid using a variety of third party services or simple facsimile transmission of appropriate evidence.

To secure the registration process, the registrant's Email address can be confirmed at step (303). This can be carried out by sending a URL link to the Email address provided that includes a hash function encrypted number using the registrant's PIN as a nonce (number used once) for the pending account. To continue the registration process, at step (304) the registrant can respond by clicking on the URL link in the RideGrid Email, which transfers control to the RideGrid Server (103, 200), which at step (306) then attempts to validate the encrypted number contained in the Email. If successfully validated, the registrant at step (307) is asked for their PIN, which if verified at step (308), the process proceeds to step (309) where further detailed information regarding registrant such as personal preferences and travel routes and schedules is entered. At step (310) the registrant is given the opportunity to join a community, as will be described in more detail below. After completing the above steps, the registration process is complete and a UserID and account are created.

During the registration process, or at a later time, the user may associate multiple users with a single account. Users are assigned a unique RideGrid UserID and accounts are assigned a unique RideGrid account ID. The UserID will be visible to other users in communications and elsewhere when rides are offered or received. During the registration process the RideGrid Server (103, 200) will authenticate each user's Email address. The user's profile is not usable for providing or obtaining rides until this is complete. The account is not active until at least one valid user is attached.

The purpose of the RideGrid routing function is to provide optimal matching of Driver and Rider itineraries. For example, if a Driver is going from source point A to destination point B, and a Rider wants to go from source point C to destination point D and points C-D are en route between A and B, the RideGrid system must be able to carry out a routing algorithm that determines whether a compatible match exists between Rider with Driver. As can be appreciated, efficient, accurate, and timely matching are important attributes of the routing function. These approaches may be based on the system of geographic mapping of degrees of latitude and longitude, although other, less precise methods could be used. Nowadays, there exist readily accessible databases with very precise and accurate latitude and longitude coordinates corresponding to virtually every street, highway, and landmark location. Converting user street address or landmark information to latitude/longitude coordinates thus provides a convenient and universal basis for matching Driver and Rider itineraries.

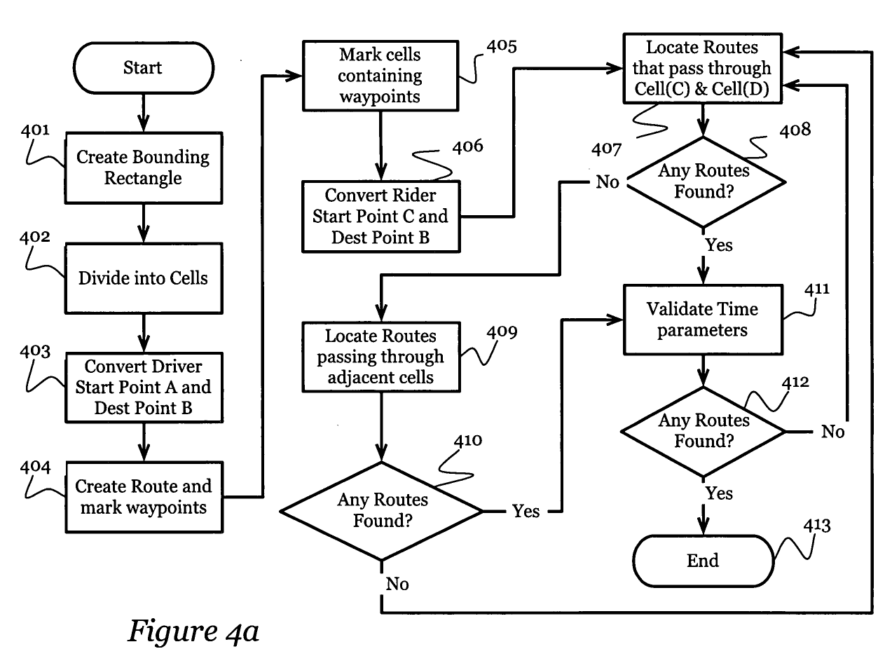

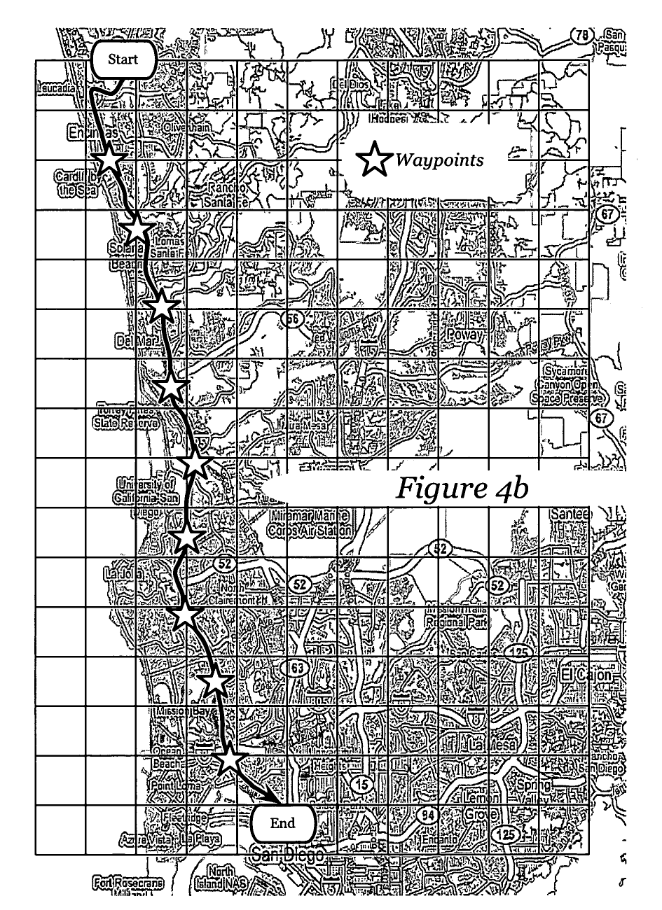

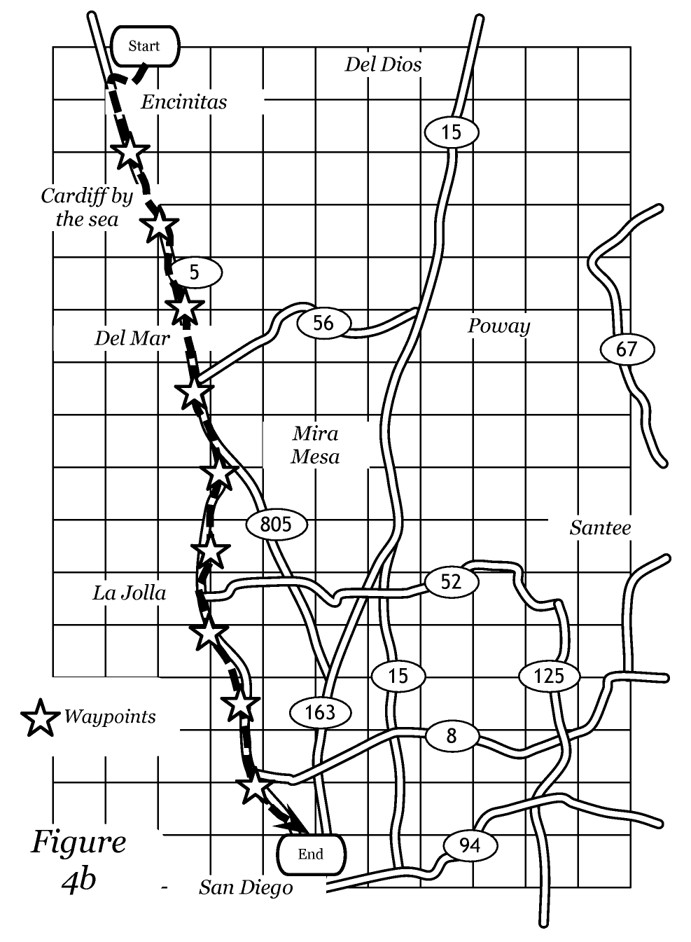

To accomplish an efficient routing system, the algorithm depicted in FIG. 4, may be utilized. Consider a geography within which the routes for Driver and Rider require matching. An example could be continental United States, or it may be some conveniently determined metropolitan region. First, at step (401) a bounding rectangle is created around the chosen geographic region. This ensures that entire region of interest is completely contained within this rectangle. Next, at step (402) this bounding rectangle is divided into cells of any reasonable dimension. For example, one degree of latitude is approximately 69 miles, so a convenient cell dimension might be one mile or 1/69 degree. As will be readily appreciated, one degree of longitude is only 69 miles at the equator and, in fact, decreases as a cosine function of the latitude north and south of the equator. To account for this fact, the routing system can keep a lookup table indicating the area dimensions at each latitude/longitude location in the grid. Alternatively, the routing function can simply calculate the cosine function “on the fly” for longitude distance versus latitude.

When a Driver indicates departure to RideGrid from source point A to destination point B in terms of address or similar location information, points A and B are encoded into their geographic locations in terms of latitude/longitude at step (403). Then, at step (404) a route is created from A to B along an optimal roadway path in a manner similar to how this routing is accomplished by services such as MapQuest or Expedia. Additionally, the routing function creates waypoints along the route at appropriate intervals and expresses them in terms of latitude/longitude. FIG. 4b depicts an exemplary route created by the routing function showing start, end, and waypoints. Waypoint intervals can be arbitrarily chosen, but may be advantageously related to Driver routing tolerances; e.g., the waypoints can be approximately ½ the distance a Driver is willing to deviate from his nominal route in order to ensure adequate sampling of the route. For example, if the route is 10 miles, 19 waypoints can be created ½ mile apart from start to end, not including start and end points. These waypoint coordinate data, along with the start and destination, are then entered at step (405) into the corresponding latitude/longitude cells in the matrix within the bounding rectangle. The bounding rectangle is a matrix of cells and the start, destination, and waypoints each have their own latitude/longitude coordinates. Since the top/left and right/bottom latitude/longitude of each cell corresponds to the maxima and minima cell coordinates, respectively, this allows a simple computation of which row/column in the matrix a given waypoint point falls. All cells that routing points (start, destination, and waypoints) reside in are marked and the cells associated with that particular route.

When a rider requests a start C and destination D at step (406), these locations are also translated into latitude and longitude information and the routing function searches to see if there are any routes passing through the cells that contain these points, or any of the adjacent cells depending on the allowed route deviation distance. If any Drive routes are found at step (407) passing through both points C and D, then a match may be achieved. Based on the lookup table of area of each cell along each latitudinal direction, a decision can be made at step (408) if there is any need to look up adjacent cells at step (409). Alternatively, the number of adjacent longitude columns to include in the search can be calculated on the fly, based on the cosine of the latitude. If Driver and Rider cells are matched at steps (408) or (410), then the process proceeds at step (411) where an alternate route is found using third party street mapping providers and, if within the Driver's route deviation tolerance, whether the Driver and Rider temporal schedules also match. Step (411) can utilize quasi-real time or historical traffic conditions to calculate estimated times of arrival (ETA's) for the start and destination points of the Rider. If a temporal match is achieved at step (411), the process is successful. If matches at steps (410) or (410) are unsuccessful, the flow reverts to step (407) and the search for a match continues.

The routing function must match the temporal requirements of Driver and Rider. To achieve more accurate temporal matching at step (411), the time required to reach each waypoint can be based on route metadata like road speed, traffic information, detours etc, which will provide a more accurate basis for estimating how long it will take to reach each waypoint from the starting point, and between waypoints. This information can be updated in quasi-real time as certain metadata changes. For example, if traffic information comes in every 15 minutes, waypoints can be updated every 15 minutes for each route in progress, based on which segments have changed and if any routes fall into the change in area for metadata. If a driver is not GPS capable, current location is estimated based solely on waypoint metadata. For GPS capable Drivers, exact current locations can be tracked. At the time of this writing, only a few mobile phones commercially available in the United States provide interfaces for applications such as RideGrid to access GPS location data, but it is expected that this functionality will eventually become ubiquitous. For those wireless communication devices without embedded GPS capability, many have access to external GPS devices that can provide location streams over a Bluetooth interface. The RideGrid system could enhance the convenience and utility of the routing function by enabling routing parameters to be transferred from the wireless device to the GPS device. In this scenario, the Driver's wireless device would not need to be GPS capable, with real time position and street routing functions accomplished entirely within the local GPS device.

Based on current location and metadata associated with waypoints, estimates can be made of how long it will take the Driver to reach a Rider's location. If this estimated time falls within the tolerance provided by the Rider, a match is achieved; otherwise, pick the next best temporal match or continue the search from the beginning in case new drivers have joined the system.

Maintaining a lookup table for every longitude/latitude cell reduces the time complexity of matching Driver and Rider to at the cost of memory space. However, since the only data stored are latitude and longitude information in a matrix, data storage space requirements are very manageable. For example, the area of the continental United States is approximately six million square miles. If the route matching function keeps a matrix of this area with approximately ½ sq mile for each cell, with latitude/longitude information at each node which is a floating point typically 8 bytes, we come up with space requirements of approximately 375 MB to store the entire matrix in memory. Considering the fact that personal computers typically have many gigabytes of memory, this memory requirement should not be an issue, even if a matrix covering the entire United States is implemented. If space is an issue, then sparse matrices can be used for implementing this algorithm such that only cells that actually have routes passing through them are represented, thereby dramatically reducing memory footprint.

Variations of the above routing function can also be utilized. For example, instead of implementing a latitude/longitude lookup table based on equal distances, the routing function could perform all necessary calculations ad hoc. This would require only storing data for actual driver route and rider departure and destination coordinates. Assume that a Driver is willing to drive about one (1) mile out of their way to pick up a Rider. Pick waypoint coordinates every ½ mile per the Nyquist sampling theorem to ensure sufficient overlap between the waypoints; i.e., pick waypoints that are about ½ the distance a particular driver is willing to depart from their route. Next, calculate the allowed route departure error for all of the waypoints along the route As an illustrative example, assume a Driver departs from Oceanside to San Diego along a route that passes through waypoints with the coordinates A (33.19750; −117,36528) and B (34.17167; −117.333333). The allowed departure in degrees of latitude is always ±D(lat)/69 or for D=1 mile, ±0.014493°. For the route departure in longitude, include the latitude cosine factor, so the allowed deviation from the nominal route in degrees of longitude is D(lon)/69 cos(lat) or ±0.017320°. Thus, we have for waypoint A, a tolerance of(33.19750°±0.014493; −11736528°±0.017320°). Similarly, for waypoint B we have a tolerance of (34.17167°±0.014493°; −11733333°±0.017534°) In this example, if there is a Rider wishing to depart from a point C with coordinates within the tolerance range of point A and with a preferred destination D within the tolerance range for point A, we have a geographic match.

Summarizing the above process, for every waypoint for the Driver's route, a tolerance distance is calculated according to a particular driver's preference and that waypoint and tolerance data entered into a database. Then, if a Rider that wishes a ride from geographic coordinates the vicinity of A to geographic coordinates in the vicinity of B, the database is queried to see if any Driver has waypoint tolerances that include those points; i.e., that the requested departure and destination coordinates latitudes and longitudes are within the waypoint tolerance limits.

As can be readily appreciated, there are expected to be some “trust” issues associated with using RideGrid. Considering the fact that the RideGrid system provides a way to dynamically get people together to commute from one place to another, there is a fundamental question of how to trust the person that a user is getting in car with, and vice versa. To address this problem, RideGrid provides “Trusted Communities” or “Private Communities”. Communities of people sharing a common bond or element reflects a natural form of trust for certain activities between the members of those communities. The RideGrid system can advantageously utilize these shared elements to create communities of riders and drivers that are willing to ride with each other. In addition, riders and drivers can be a part of private communities which require some sort of proof of identity for membership. This allows the rider and driver to be confident that they are indeed riding with the actual people they claim to be. In addition, there are ride preferences which can cover a wide variety of issues such as smoking, non-smoking, type and make of cars to ride in etc.

Even within so-called trusted communities, individual privacy is still a widespread concern. In response to this concern, the RideGrid system can provide complete anonymity between all users; that is, no personal information such as Email address, phone number, address, or other identifying information is passed between users, be they Driver, Rider, or Community Administrator. Methods of achieving anonymity or “double-blind” communications between users are well known and practiced in networking environments in general and in regard to social networking services in particular.

The RideGrid system also allows user to express a RideBuddy list and RideBlock list. The active users in the buddy list can be any RideGrid users. The RideBuddy list can be created with individual entries or with a simple upload of a representation of the user's online address book in common formats such as Comma Separated Value (CSV) or vCard. If a targeted buddy is already a RideGrid user, RideGrid may initiate a dialogue to ensure that person is willing to be the originator's buddy. If the targeted buddy is not a current RideGrid user, the user creating the list may be given the option to contact such users by Email to tell them about RideGrid, and a referral mechanism occurs. In any case, the referral is stored in a database for future use in case those proposed RideBuddies later become RideGrid users, at which point they will be connected asynchronously and automatically; a successful referral results in a RideBuddy relationship.

The RideBlock list has two forms: the typical use is intended to prevent matching with a common community member after an initial match and subsequent shared ride has occurred; in this case the users may not know anything about each other except the experience of their ride. The second RideBlock use is for when a person trusts a Community but knows members of that Community that they do not want to ride with; this form is similar to the RideBuddy list but has the opposite effect. A RideBlock list can also be created so that irrespective of any other criteria, a user can exclude someone from matching with them. The contents of the RideBlock list can be confidential. The RideBlock list takes precedence over the RideBuddy list, so that if a user changes their mind on a buddy, they can choose not to ride with them without otherwise hurting their relationship. An option to invoke RideBlock can appear at ride conclusion along with the evaluation screen. A user can also initiate this function at any time from the log screens.

RideGrid provides a community listing service, where a RideGrid user can search by keyword, regular expression ((just a simple one with * for wildcard to reduce complexity), zip code, or Administrator Email address. RideGrid will present whatever information the Administrator agrees to give out to prospective community members. This could be the Administrator's name, address, Email address, phone number, or any combination, although, due to the double blind security system employed during Community joining, there is no need for RideGrid to provide any administrator information at all. Moreover, by being able to provide matching credentials for the applicant as described below, Administrators indirectly authenticate themselves. Requiring restricted contact information in this way prevents the user from spamming the Administrator and from randomly and indiscriminately joining communities.

In order to join a trusted community, the user must already be a legitimate member of the group which formed the community. For example, in order to join an employer's community, the user must actually be employed by that employer, and have in his possession the credentials to prove it. The Subscribe to Community function is illustrated in the logic flow diagram of FIG. 5. At step (504), the applicant provides his credentials to the RideGrid system; RideGrid sends an Email to the Community Administrator at step (505) with the applicant's Email address and name, and the Administrator sends the applicant's to RideGrid at step (513) as well. RideGrid compares the two at step (514) and, if matched at step (515), confirms to both parties at step (517). If not matched, at step (516) the Administrator is given a second chance to check or enter the data again. If the Administrator confirms that the data does not match, then the applicant is denied and must start over. Through this mechanism, the Administrator can prove the applicant is who they claim without ever having to see or speak with them directly. Moreover, because the authentication data provided by the applicant is never given to the Community Administrator, the applicant is assured that the Administrator is who they say they are as well.

For trusted communities, the Administrator may be requested to define a set of fields which will be required for authentication. Both the description and the data itself can be free form text, up to a maximum number of characters. For example, the Administrator can ask for “Driver's License number or other government ID number”. These must be credentials that the Administrator can produce for any individual whose Email address, name, or similar identifying information is submitted by RideGrid for verification.

A RideGrid user can also be referred to a community. This indicates that the user being referred feels comfortable with any member of that community and would give rides to or receive rides from any member of that community. This is not necessarily a reciprocal relationship. When rides are brokered through a referral, this may be communicated to the matched party differently, such as indicating to the other party that someone in their community thinks the referred member is trustworthy and the identity of that community from which the referral originated.

To get a referral to a community, once the RideGrid Community Manager (212) has located a community, there is a link on the page that says “get a referral to this community” or similar. Clicking this link asks for an Email address of someone who is a member of that community. If the user can provide contact information for a potential referrer, RideGrid solicits the referral using a personalized request message provided by the applicant, or with generically worded request provided by RideGrid. It sends an Email containing the referral request to the identified member of the target community, providing the applicant's Email address and name, with a link to create the referral link.

Any RideGrid member can create communities. They will become the Administrator for the community (they can add other communities as well). Communities of all types get, at a minimum, a name that is searchable. They can also be associated with a zip code, if one is applicable, or other attributes deemed relevant to assisting a user's choice.

Buddies are much more straightforward than communities. A RideGrid user must know at a minimum a person's Email address to be able to add them to their buddy list. For example, if user A enters person B's Email address, RideGrid checks to see if B is already a RideGrid user. If so, RideGrid sends B an Email asking to confirm if it is OK to add A to B's buddy list and A must likewise confirm their approval to add B to A's buddy list. The Buddy relationship is reciprocal and symmetrical.

In order to receive rides, a credit balance exceeding the requested ride cost by a fixed percentage must be present in the user's account. Credits are correlated with miles ridden or driven. Users can purchase credits in convenient sizes measured in their local currency: e.g., common sizes could be approximately $100. A service fee can be deducted from the initial amount, with the remainder deposited into a reserve account to be dispersed to drivers or any RideGrid member selling credits to RideGrid. At the completion of a ride delivered by a Driver for a Rider, the RideGrid system transfers credits from the Rider's account to the Driver's account in an amount equal to the shared distance in miles plus the deviation from the driver's original route to pick up and drop off the Rider. The deviation can be readily calculated by comparing the distance traveled along the deviated route to that of the undeviated route: simply subtract the undeviated route distance from the deviated route distance. If this difference is positive, it is added to the amount the driver is compensated. The conversion between RideGrid credits and local currency could be conveniently based on current standardized reimbursement rates. For example, the United States General Services Administration publishes Privately Owned Vehicle (POV) mileage reimbursement rates for federal employees who use privately owned vehicles while on official travel. Using such a basis for currency conversion would provide the flexibility to adjust the cost of RideGrid credits in response to changes in vehicle operating costs. Any account with nonzero balance can be sold back to RideGrid by essentially reversing the process by which RideGrid credits are purchased. Since RideGrid takes its fee off the top, there is no necessity for a redemption fee and RideGrid can simply send a payment utilizing check or online service such as PayPal, after confirming with the user, to the address of record.

The RideGrid system can optionally provide users with the opportunity to evaluate the quality of a ride. They can evaluate the other as a rider or driver using a fixed 1-N scale. Rating is what the user has as an aggregate measure of their evaluations. It can increase linearly for good evaluations, but decrease hyper-linearly for credible bad evaluations. The amount of negative effect may also take into account the rater's normal evaluation; e.g., if a rater tends to give bad evaluations then their evaluation ratings can be normalized to reduce their rating bias. Following these practices has the effect of taking a relatively large number of favorable ratings to build a good reputation whereas only a few bad ratings will project a bad reputation. The rating is presented as an integer, 1-N. New members get a nominal rating.

Users enter the RideGrid system either directly through the Web portal or mobile device, or by virtue of automatic temporal routing. When RideGrid finds a potential Driver for the Rider, they are added to a list on the client device. For each of these potentials, the RideGrid system calculates a composite route through its routing function so that the cost and estimated arrival time can be presented to the Rider. The list includes a reference ID, rating of the driver, the cost and estimated arrival time. No information regarding their identities or any other property of the Driver or Rider is divulged. When a Rider selects a Driver from the list, the Driver is sent a message offering the proposal. If the Driver accepts, both device screens show ride agreement, and the Driver may be routed to the Rider using turn by turn instructions in text or audio form. The Rider is given the Driver's car attributes including car color, type and license plate. Both clients are provided a photo of the person they will be riding with, assuming their device supports it. Both users display whether the other member has an Internet enabled mobile device and whether or not GPS is available. When the driver gets close, assuming RideGrid knows the proximity from quasi-real time GPS tracking, the rider is alerted so they can hold up their hand in a crowd and watch for the car. The driver is looking for someone with their hand up who looks like the photo they have on their device.

Once they meet, the Driver initiates the pick up sequence, which sends an alert to the Rider's phone asking for confirmation. If there is no confirmation, they should not ride together unless either member has no mobile device. If confirmed, they ride together, and when they reach the Rider's destination, the Driver initiates the ride completed sequence, which sends a message to the Rider's mobile device asking for validation that the ride is completed. Once confirmed, the credits for the ride transfer from Rider to Driver. If not confirmed, the two can do the conclusion later. RideGrid can send mail at regular intervals until the confirmation takes place. If the Rider never confirms or denies, after some period of time it confirmation can be tacitly assumed and the credits transferred.

While certain embodiments of the inventions have been described above, it will be understood that the embodiments described are by way of example only. Accordingly, the inventions should not be limited based on the described embodiments. Rather, the scope of the inventions described herein should only be limited in light of the claims that follow when taken in conjunction with the above description and accompanying drawings.

What is claimed is:

1. A method for spontaneously connecting trusted travelers for the purpose of provisioning a one time ride for a rider by a driver, comprising:
Entering supporting data into a database, describing the static parameters of future needed or offered rides, then requesting and offering such rides through telephony, mobile internet, or internet browser devices, creating routes from actual in-progress drives, future planned drives, requested end points and requested routes.
Whereby a rider and driver who have never met can be introduced wherever they are, with whatever mobile device they happen to be carrying, such that the driver may ultimately deviate from his or her original route within a specified tolerance in order to pass through the current location and desired destination of a willing and compatible rider.

2. The method of claim 1 wherein: driver and rider are connected through the system because they already know each other, or trust each other by association, thereby simplifying the connection semantics suitably to enable connection for a single use. Further, that if rider and driver decide after riding together that they don't wish to be matched again, the system allows them to so indicate during closing processes, and that such action is never disclosed to the other party.

3. A method for quantitatively evaluating similarity of routes of millions of users simultaneously. Comprising: a translation of end points of a desired or planned route into tiles in a grid which then are then colored if touched by a route and the driver's tolerance, then comparing these colored tiles with those colored by the rider's desired route. This method is linear with respect to the number of tiles in the aggregate of all routes.
